(19) United States
(12) Patent Application Publication
(10) Pub. No.: US 2002/0143987 A1
(43) Pub. Date: Oct. 3, 2002

(54) Message management systems and method

(76) Inventors: Andrew Paul Sadler, Essex (GB); Craig Phillip McMillan, London (GB); Andrew John Patterson, Chatham (GB); David John Durbin, Victoria (AU)

Correspondence Address: B. Noel Kivlin, Conley, Rose, & Tayon, P.C., P.O. Box 398, Austin, TX, 78767, US

(21) Appl. No.: 09/934,184

(22) Filed: Aug. 21, 2001

Related U.S. Application Data
(60) Provisional application No. 60/226,819, filed on Aug. 22, 2000.

(51) Int. Cl. G06F 15/173

(52) U.S. Cl. 709/238

(57) ABSTRACT

A method and system for routing messages comprising: converting a message received from a sender into an internal format comprising at least an attribute part and a data part, writing into said attribute part data extracted from said received message; and routing said converted message in dependence on the data in said attribute part.

### BACKGROUND OF THE INVENTION

The invention relates to a system, apparatus, method and computer program for message management.

Business-to-business electronic commerce is already a significant part of global economic activity. It is predicted that by the year 2003, 9% of total global sales to businesses will be conducted over the Internet. The benefits to business are clear, namely decreased operational costs, access to larger markets and improved customer services, which combine to deliver greater profitability.

Past efforts to implement electronic market places have been hindered by high set-up costs and interoperability issues. Whilst the development of the Internet has addressed, and in great part overcome, the high set-up costs and interoperability problems and thereby focused awareness on the potential for business to business e-commerce, security issues surrounding use of the Internet are holding back the growth of e-commerce. Trading over open networks such as the Internet involves new risks, especially the issue of trusting the identity of trading partners. Systems which check the identity of online parties are therefore required.

Several authorisation, verification and authentication mechanisms are currently in use in Internet based e-commerce systems, employing Public Key Infrastructure (PKI) techniques including digital signatures and digital certificates. These systems are each written for a specific application of the system and typically comprise a plurality of vertical stacked services or applications, each of which is written for that particular system. There is no cross-linking of these components and therefore one cannot re-use them.

In PKI, pairs of different keys are used, one key of each pair being a “public key”, K_{P}, which can be made public, and the other being a “private key”, K_{S}, which remains secret. It is relatively easy mathematically to derive the public key from its private key, but the opposite is not true. Specific operations with one key can be undone with the other key. For example, if a document is encrypted with a public key it can be decrypted with the corresponding private key, and if a document is encrypted with a private key, it can be decrypted with the corresponding public key. Thus, a complete stranger can use a public key to encrypt a message, but only a specific person with the corresponding private key can decrypt the message. Alternatively, a specific person can encrypt a message with their private key, and complete strangers can decrypt the message with the corresponding public key.

Digital Signatures

Digital signatures are used to verify that a communication has not been tampered with and that it is from the specified sender. Typically a digital signature is contained in a file attached to the relevant communication. A first person, ‘A’, can sign a document by encrypting it with A's private key, K_{S}^{A}. If A then sends the signed document to a second person, ‘B’, B can verify the signature by using A's public key K_{P}^{A} to try to decrypt the signed document. If the public key works, i.e. results in a legible message, then there is a high probability that the signature is verified, verifying that the document was sent by A (or someone who knows A's private key).

In practical implementations, public-key algorithms are often too inefficient to sign long documents. To save time, digital signature protocols are often implemented with one-way hash functions. A hash function is a function that takes a variable-length input string (called a pre-image) and converts it to a fixed-length (generally smaller) output string (called a hash value or digest). This ‘fingerprints’ the pre-image. The hash function can be public. The security of a one-way hash function is dependent upon its one-wayness. A good hash function for digital signature protocols has an output which is not dependent on the input in any discernible way. A single bit change in the pre-image changes, on average, half of the bits in the hash value. Given a hash value, it is computationally unfeasible to find a pre-image that hashes to that value. In these types of protocols, both the one-way hash function and the digital signature algorithm are agreed upon beforehand.

So, A produces a one-way hash of a document, encrypts the hash with A's private key K_{S}^{A} thereby signing the document, and then sends the document and the signature, i.e the signed hash, to B. B will then produce a one-way hash of the document that A sent. Using the digital signature algorithm, B decrypts the signature with A's public key K_{P}^{A} to derive the signed hash. If the signed hash matches the hash generated by B, the signature is valid.

The amount of information required to be checked is significantly reduced and thus the speed of verification is greatly increased. Since the chances of two different documents having the same n-bit hash are only 1 in 2ⁿ, one can usually safely equate a signature of the hash with a signature of the document.

Digital Certificates

Digital certificates are a form of electronic identification linking an individual to a particular cryptographic key, such as a public key K_{P} in a PKI system. They provide a container for the public key K_{P}, including the name of the owner of the public key and a digital signature of a guarantor of the public key. The guarantor certifies that the information given about the individual is correct and that the public key belongs to that individual. Usually, the certificate is digitally signed by using the guarantor's private key to encrypt a hash of the certificate.

Guarantors of digital certificates are usually called Certification Authorities. They are trusted not to substitute a public key in a certificate with that of another party. A trusted CA, such as VERISIGN or UNICERT, assigns a unique name to each user called the Distinguished Name (DN). CAs issue certificates which include this DN as well as a serial number unique within that CA, the issuer (CA) name, the algorithm used to sign the certificate, the period of validity of the certificate, the user's public key Kₚ^{user}, and the digital signature of the CA.

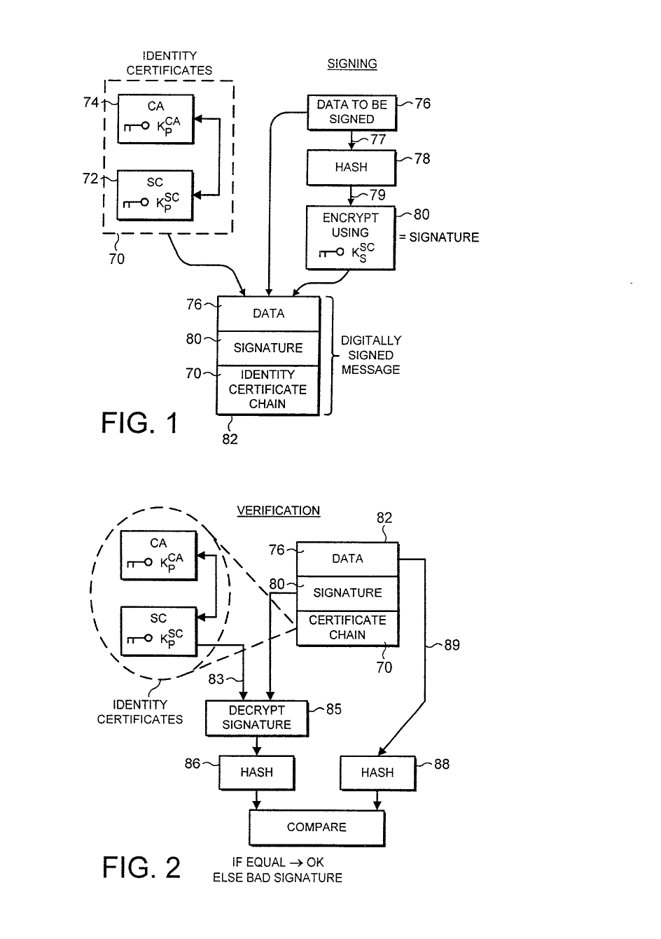

FIG. 1 shows the process of signing a digital message. A subscribing customer SC is issued with (and keeps for a certain length of time, usually five years), a certificate chain 70 and a private key with which it can digitally sign certificates. The certificate chain 70 includes a certificate 72 including the subscribing customer's public key Kₚ^{sc} and the details about the subscribing customer, signed by a CA, and a certificate 74 including the Certifying Authority public key K_{P}^{CA}, as well as data identifying that CA, signed by its own secret key if it is a root CA.

In some circumstances an SC may be issued with a private key and certificate together to achieve greater simplicity albeit at the expense of some security. This is preferably achieved by the SC first generating its own private key and using this to sign a request for a certificate. It then sends this request to the CA which then issues the certificate. This procedure is more secure as the private key never leaves the SC's possession.

The data part 76 of a message to be sent by a subscribing customer, SC, is first hashed 77. The hash 78 is then encrypted 79 using the subscribing customer's private key, K_{S}^{SC}, to provide a SC digital signature 80. The data part 76, digital signature 80 and certificate chain 70 are then all combined into a signed message ready to be sent.

FIG. 2 shows the process of verifying the signature of a signed message 82. The public key of the sender (SC) of the message is extracted 83 from the certificate chain part 70 of the message and used to decrypt 85 the signature part 80 of the signed message. This decrypted signature forms the first hash value 86. The data part 76 of the message is also hashed 89, to provide a second hash value 88. These two hash values are then compared and if they are equal the signature is verified. Otherwise it is a bad signature, and the message will be rejected.

One certificate validation service is being developed by a consortium of banks, under the name IDENTRUS. This aims to provide business-to-business financial institution authentication to facilitate financial messages.

Embodiments of the present invention aim to provide an interface between a certificate validation service, such as the IDENTRUS system, financial institutions and end-users.

The present invention is defined in detail in the appended claims to which reference should now be made. Combinations from the dependent and/or independent claims may be combined as appropriate and not merely as set out in the claims.

### SUMMARY OF THE INVENTION

In a first aspect of the present invention there is provided a method for routing messages comprising: converting a message received from a sender into an internal format comprising at least an attribute part and a data part, writing into said attribute part data extracted from said received message; and routing said converted message in dependence on the data in said attribute part.

In a second aspect of the present invention there is provided a program element comprising program code for configuring a computer system to route a message, the program code operable to:

convert a message received from a sender into an internal format comprising at least an attribute part and a data part;

write into said attribute part data extracted from said received message; and

route said converted message in dependence on the data in said attribute part.

In a third aspect of the present invention there is provided a computer-readable medium encoded with computer-readable program code as set forth above in respective paragraphs.

In a fourth aspect of the present invention there is provided a computer system for routing messages to one or more services comprising:

a parser for converting a message received from a sender into an internal format comprising an attribute part and a data part, said attribute part containing data extracted from the received message; and

a router for routing the converted message in dependence on the data in said attribute part.

In a fifth aspect of the present invention there is provided a computer network comprising at least one computer system connectable to at least one further computer system via a network, the at least one computer system comprising:

a parser for converting a message received from a sender into an internal format comprising an attribute part and a data part, said attribute part containing data extracted from the received message; and

a router for routing the converted message in dependence on the data in said attribute part.

Particular embodiments of the system provide a single, unified authorisation service for all services in a multi-service message environment applications, which can be used within a single organisation to provide authorisation services across a range of legacy systems, or in multi-party environment as the basis for commercial services between, for example, banks and their corporate customers, or both.

The system uses public key technology to authenticate end users and services that use the authorisation service to determine the facilities, levels of access, or to request a form of warranty, before completing a message with the end user.

The system enforces policy rules across all applications with or in an organisation. It centralises all administration functions and provides a common authorisation service for all business systems. The system allows the management of digital certificates and keys belonging to PKI across a number of hardware and software products.

Illustrative embodiments of the invention will now be described with reference to the drawings in which:

FIG. 1 shows schematically the signing of a digital message;

FIG. 2 shows schematically the verification of a digital signature;

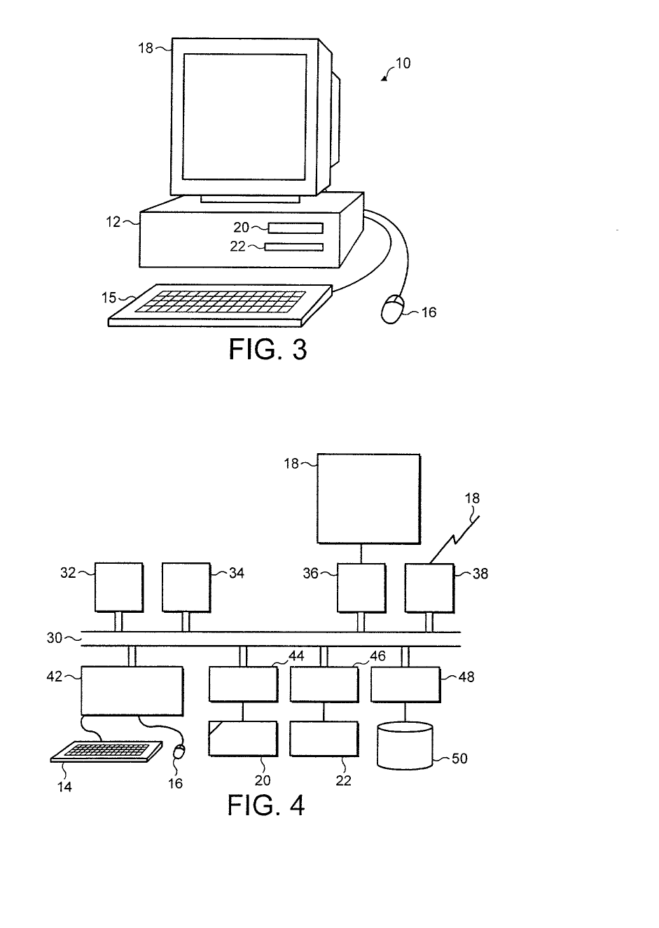

FIG. 3 shows a schematic representation of a computer workstation for an illustrative embodiment of the invention;

FIG. 4 shows a schematic block diagram illustrating an illustrative embodiment of a computer workstation as show in FIG. 3;

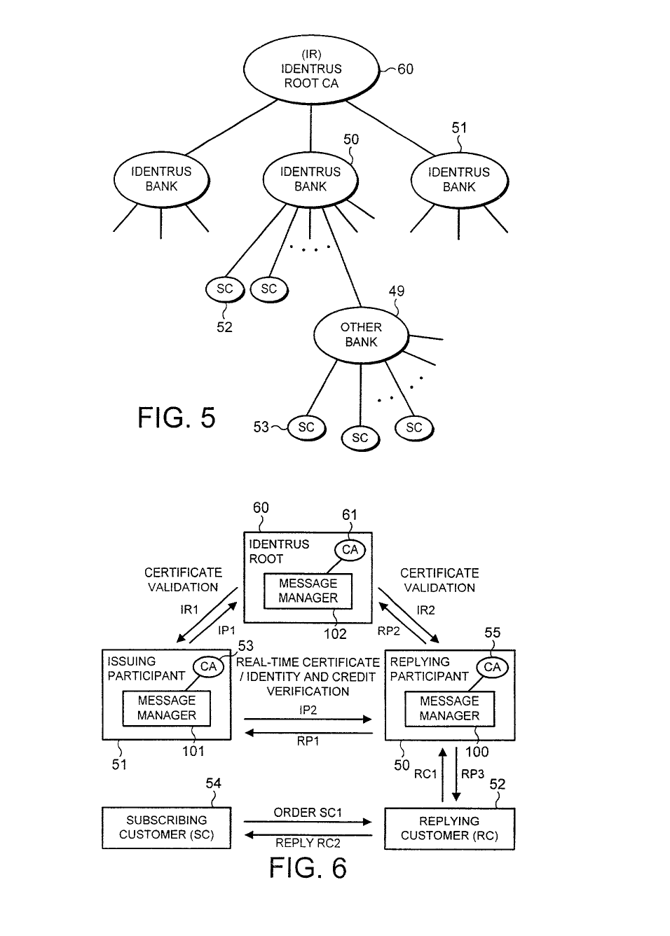

FIG. 5 shows the typical hierarchy of certificate authorisation;

FIG. 6 shows a typical message in a network embodying the invention;

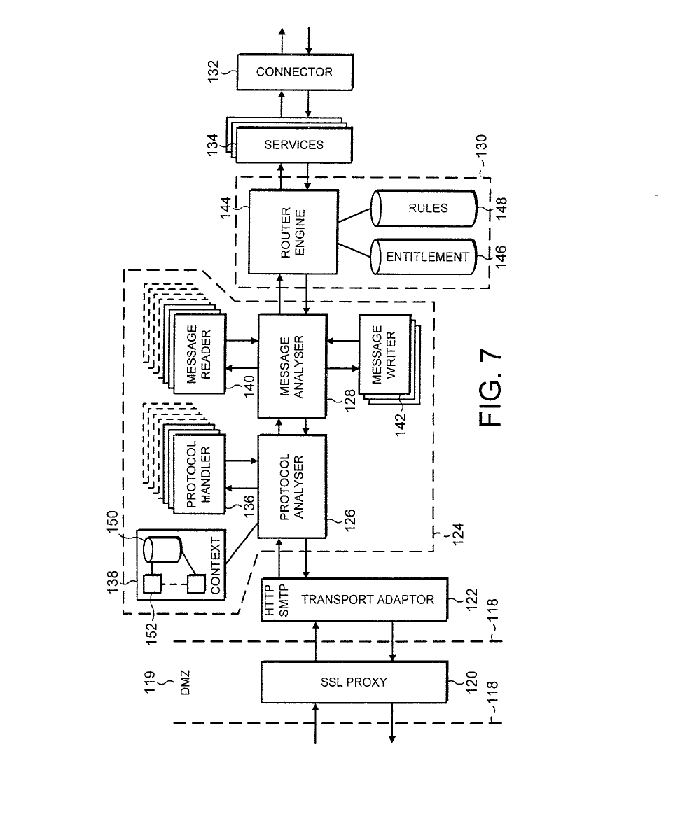

FIG. 7 shows schematically an illustrative embodiment of the message manager;

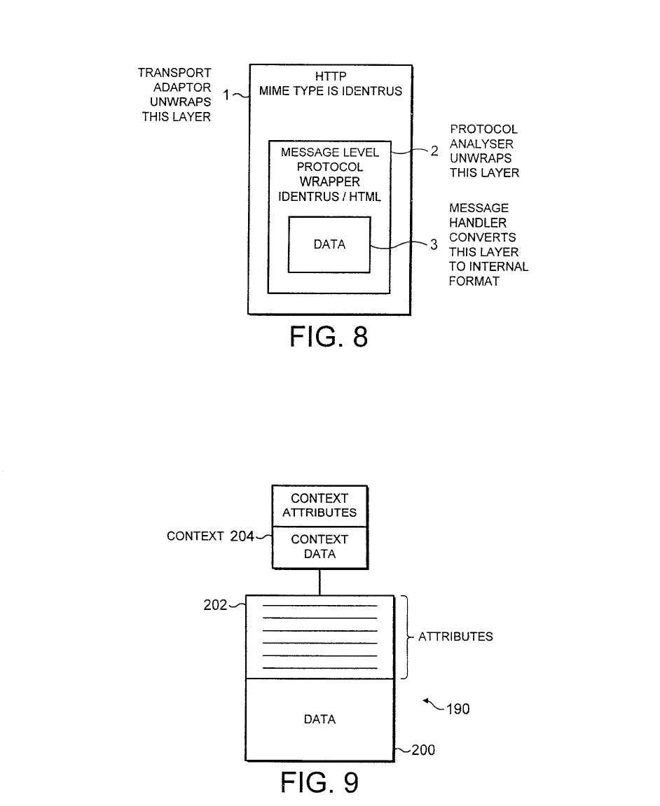

FIG. 8 shows schematically the various protocol layers of a received message;

FIG. 9 shows an example of a trustbase message format; and

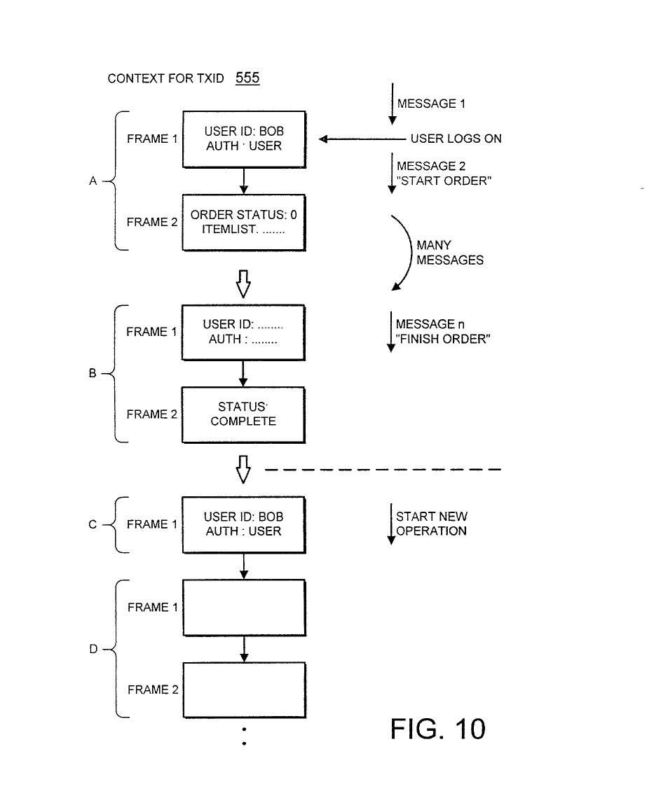

FIG. 10 shows example of the frame stores used for context data.

FIG. 3 is a schematic representation of a computer workstation on which an illustrative embodiment of the invention is implemented. As shown in FIG. 1, a computer workstation 10 includes a system unit 12 (an example of the configuration of which is shown in FIG. 2), user input devices, for example in the form of a keyboard 14 and a mouse 16, and a display 18. Removable media devices in the form, for example of a floppy disk drive 20 and an optical and/or magneto-optical drive (e.g. a CD, a DVD ROM, a CDR drive) 20 can also be provided.

FIG. 4 is a schematic block diagram showing an illustrative configuration of a system unit 12 as shown in FIG. 3, attached to input devices 14, 16 and a display 18.

As shown in FIG. 4, the system unit 12 includes a bus 30 to which a number of units are connected. A microprocessor (CPU) 32 is connected to the bus 30. Main memory 34 for holding computer programs and data is also connected to the bus 30 and is accessible to the processor. A display adapter 36 connects the display 18 to the bus 30. A communications interface 38, for example a network interface and/or a telephonic interface such as a modem, ISDN or optical interface, enables the computer workstation 10 to be connected 40 to other computers via, for example, an intranet or the Internet. An input device interface 42 connects one or more input devices, for example the keyboard 14 and the mouse 16, to the bus 30. A floppy drive interface 44 provides access to the floppy disk drive 20. An optical drive interface 46 provides access to the optical or magneto-optical drive 22. A storage interface 48 enables access to a hard disk 50. Further interfaces, not shown, for example for connection of a printer (not shown), may also be provided. Indeed, it will be appreciated that one or more of the components illustrated in FIG. 4 may be omitted and/or additional components may be provided, as required for a particular implementation.

The message system provides certification services to a customer through the customer's bank which will, in turn, verify the customer's identity to trading partners. Customers wishing to use the system must first register and enter into an arrangement with their bank, which authenticates the customer's identity. The customer then typically receives a smart card containing a plurality of certificates and a private key for the customer. The plurality of certificates is a tree of certificates or chain, as shown in FIGS. 1 and 2, each digitally signed and enclosing the public key of the relevant CA.

Additionally, the message system will allow banks to guarantee payments by its customers. Such a guarantee would greatly reduce a seller's risk.

Referring to FIG. 5, the certification hierarchy of the above-mentioned IDENTRUS system is shown. The root CA is the IDENTRUS root IR 60. This signs its own certificates. At the next level down are the so-called IDENTRUS banks, who are part of the consortium running the IDENTRUS system. These banks 50, 51 etc can act as certifying authorities for each of their customers C 52, as well as for other banks 49 which are not part of the IDENTRUS scheme. These other banks will then, in turn, act as a certifying authority for their customers, C 53.

Referring to FIG. 6, in a particular embodiment, a message manager (“MM”) 100 is provided in each of two banks 50, 51 and in a root authority 60, called the IDENTRUS ROOT in FIG. 6. The MMs are connected by a network, for example the internet, to provide on-line, real-time certificate, identity and credit verification. The MMs provide routing, messaging and identity checking services and can sit in front of the legacy systems of the banks 50, 51.

A transaction will now be described, in which a “subscribing” customer 54, whose bank 51 is called the issuing participant IP, sends an order to a “relying” customer RC 52, whose bank 50 is called the relying participant RP. An example of such a message is when a purchaser 54 wishes to make a purchase from a manufacturer 52. The prospective purchaser 54 will send a message to the other party, for example: “How much will you charge me for x units of y?”. In response the manufacturer will wish to forward a proposal, for example “x units of y will cost z”. Both sides will wish to check the identity of the other party and thus they need to send their requests accompanied by a suitable chain of digital certificates and appropriately signed.

To initiate a message the subscribing customer (SC) 54 sends an order (SC 1) to the relying customer (RC) 52, from which it wishes to order something. The SC signs its request message as shown in FIG. 1. The data comprising the request message is input to a suitable hash digest algorithm to generate a hash digest of the request data . The hash digest is then encrypted using the SCs assigned private key, K_{S}^{SC}, thereby providing a signature. Then it packages up to be sent the request data, the signature, and a chain of identity certificates, thereby creating a digitally signed message. The chain includes SC's identity certificate (signed by IP), and an IP CA signing certificate (signed by the Root CA), which identifies the IP CA. The data part may instead of containing the actual request data relating to the order, contain a pointer indicating where the order information may be found.

On receipt of the order message, the relying customer RC will first verify the signatures, that is both those in the identity certificates as well as the digital signature of the hash. First it will verify the signatures in the identity chain. It will extract the necessary public keys (SC's, IP's) from the identity certificates, and the Root CA public key Kₚ^{root} from a locally stored or network accessible Root CA certificate, and use these to verify the SC's message.

If the signatures are verified OK, the RC 52 will next need to check that the SC's identity and the IP's CA signing certificates have not been revoked, that is are still valid. So RC 52 will send a service request message (RC1), often called a Certificate Status Check (CSC) message, to its bank 50, the RP, including a request for a check on the status of the SC's identity certificate, and on the status of the IP CA signing certificate. This request message is signed by the RC's identity private key, K_{S}^{RC}, and contains the RC's identity certificate.

The RP's Message Manager 100 will receive this request message (RC1). The RP Message Manager extracts the RC's Identity public key from the RC's identity certificate and uses this public key to verify the RC's signature on RC1. RP also extracts the RP CA public key from the RP CA certificate stored locally, or from that contained in the certificate chain of RCs identity certificate, and uses this public key to check the RP CA signature on the received RC Identity certificate. This verifies the authenticity and integrity of the RC's request message RC1. If this request message is authentic, the RP Message Manager uses the RC's request message to construct a request message (RP1) to the Issuing Participant's (the IP's) Message Manager 101. This request message RP1 is re-signed by the RP Message Manager using the RP's Inter-Participant private key, and contains the RP Inter-Participant certificate. “Inter-Participant” private keys are those used to sign communications between Identrus participants, each participant having a unique private key.

The IP Message Manager 101 extracts the RP's Inter-participant public key from the RP's Inter-participant certificate, and uses this public key to verify the RP's signature; extracts the Root CA public key from the Root CA certificate stored locally, and uses this public key to check the Root CA signature on the RP Inter-participant certificate. This verifies the authenticity and integrity of the RP's request message. If this request message is authentic, the IP Message Manager 101 sends a request message (IPI) asking for the status of the RP's Interparticipant certificate, to the Identrus Root. The request message IPI is signed by the IP Message Manager using the IP Inter-participant private key, and contains the IP Inter-Participant certificate.

On receipt of IP1, the IR Message Manager extracts the IP Inter-Participant public key from the IP Inter-Participant certificate, and uses this public key to verify the IP Message Manager signature, and extracts the Root CA Signing public key from the Root CA certificate stored locally, and uses this public key to check the Root CA signature on the IP Inter-Participant certificate. This verifies the authenticity and integrity of IP's request message. If this request message is authentic, the Identrus Root Message Manager processes the request, that is checks the validity of the RP's Inter-Participant certificate and returns the status of that to the IP Message Manager. IR's response message (IR1) is signed with the Identrus Root Inter-participant private key, and contains the Identrus Root Inter-Participant certificate.

On receipt of IR1, the IP Message Manager extracts the IR Inter-Participant public key from the IR Inter-Participant certificate, and uses this public key to verify the IR signature. It also extracts the Root CA public key from the Root CA certificate stored locally, and uses this public key to check the Root CA signature on the IR Inter-Participant certificate. This verifies the authenticity and integrity of IR's response message. If this message is authentic, the IP Message Manager processes the original request from the Relying Participant for the status of the SC certificate, and returns the status of the SC Identity certificate to the RP Message Manager. The response message (IP2) is signed with the IP Inter-Participant private key, and contains the IP Inter-Participant certificate. To process the original request from RP, IP will check its own certificate database 53 to see whether SC's certificate is still valid.

On receipt of IP2, RP will first verify the signatures and then send a request message RP2 to IR including a request to check the validity of IP's certificates, that is both the IP Inter-Participant certificate as well as the IP CA certificate. To do this the RP extracts the IP Inter-Participant public key from the IP Inter-Participant certificate, uses this public key to verify the IP signature, and then extracts the Root CA public key from the Root CA certificate stored locally, and uses this public key to check the Root CA signature on the IP Inter-Participant certificate, thus verifying the authenticity and integrity of the IP's response message, IP2.

If this message, IP2, is authentic, the RP sends a Certificate Status Check request message RP2 to the Identrus Root asking for:

1. The status of the IP Inter-Participant certificate;

2. The status of the IP CA Signing certificate; and

3. Its own certificate for signing RC messages.

The request message RP2 is signed with the RP Inter-Participant private key, and contains the RP Inter-Participant certificate.

Next, IR will verify RP's signature and then check its database 61 to determine the validity of IP's certificate. The Root Message Manager extracts the Root CA public key from the Root CA certificate stored locally, uses this public key to check the Root CA signature on the RP Inter-Participant certificate, extracts the RP Inter-Participant public key K_{P}^{RP} from the RP Inter-Participant certificate, and uses this public key to verify the RP signature; this verifies the authenticity and integrity of RP's message, RP2.

If this message, RP2, is authentic, the Root Message Manager processes the request, and returns to the RP Message Manager:

1. the status of the IP Inter-Participant certificate;

2. the status of the IP CA certificate, and

3. the status of the RP RC certificate.

The response message, IR2, is signed by the Root Inter-Participant key, and contains the Root Inter-Participant certificate.

If IR's response message, IR2, to RP indicates that IP's certificate is valid, RP will send its customer, RC 52, a Certificate Status Check Service response message, RP3. This includes a signed, time stamped Certificate Status Check of his own credentials obtained from the Identrus Root. Without this the message fails. The checking procedure carried out by RP before sending message RP3 is as follows.

The RP Message Manager extracts the Root CA public key from the Root CA certificate stored locally, uses this public key to check the Root CA signature on the Root Inter-Participant certificate, extracts the Root Inter-Participant public key from the Root Inter-Participant certificate, and uses this public key to verify the Root signature; this verifies the authenticity and integrity of the Root's message IR2.

If this message, IR2, is authentic the RP Message Manager can trust the Root Message Manager, the IP Message Manager, and the status of the SC Identity certificate. Then, the RP Message Manager sends a message (RP3) responding to the RC's original request and containing:

1. the status of the SC Identity certificate. Note that if any of the back office checks on the IP fail, then the SC check is marked as a failure.

2. the RP certificate status check response from the Identrus Root. Note that this may be copied directly from message IR2.

This message, RP3, is signed with the RP relying-customer private key, and contains the RP Relying Customer certificate.

The RC must check the signature and time stamp of the Identrus Root check received through the Relying Participant. The system implements a time limit parameter for accepting time stamped credentials of the Relying Participant. Where a time stamp falls outside this period, the message fails. A message, RC2, responding to the original request message is sent by the Relying Customer, confirming or denying the request, as appropriate based on the Certificate Status Check response received by RC.

Referring to FIG. 7, the main components of a message manager 100, 101, 102, in a particular embodiment, include a secure socket layer (SSL) proxy 120, transport adapter 122, parser 124, router 130, plurality of services 134, and a connector 132. The SSL proxy provides a multi-channel input and uses PKI methods to authenticate the end points of communications, providing privacy from third parties. It exchanges digital signatures and checks them.

The transport adapter 122 deals with the specifics of mail/transport protocols such as Hyper Text Transfer Protocol (HTTP) and Simple Mail Transfer Protocol (SMTP). It subtracts the transport protocol from an incoming message, unwrapping the transport protocol layer. The transport adapter reads any Multimedia Internet Mail Extension (MIME) type of the message, and passes this, along with the partially unwrapped message to the parser 124.

The parser 124 translates the incoming message into the Message Manager's internal format, which will be described later, and then passes the message on to the router 130. The parser comprises a protocol analyser 126, a plurality of protocol handlers 136, a context engine 138, a message analyser 128, a plurality of message readers 140, and a plurality of message writers 142.

The protocol analyser (PA) 126 has two main responsibilities, namely to establish the context for the message, and to determine the type of the data contained in the message, that is the format in which the data is in, for example html or IDENTRUS format. Each protocol handler is configured to ‘understand’ a particular type of message. The PA determines the type of data from the transport/main protocol used. Depending on the type of data and context of the message determined the protocol analyser selects a protocol handler, and passes the message to the selected handler. The protocol handler then strips away the message level protocol wrapper. The message is next passed to the message analyser.

The message analyser (MA) 128 passes the message on to one of the plurality of message readers 140, selected in dependence on the message level protocol used which is notified to the MA by the PA. The message reader then converts the message from that message level protocol into an internal format and then passes the message on to the router 130.

A message 190 in the internal format of the MM, called herein a trustbase message, comprises two parts, as shown in FIG. 9, namely an attribute part which identifies a plurality of attributes of the message including by what protocol the data arrived, details of any digital certificates, the SSL client, etc., and a data part and the message has an associated context packet which identifies the context of the operation, and will be described later in more detail. The data part 200 is usually opaque to the Message Manager framework, and the framework only needs to read the information listed in the attributes section 202 of the trustbase message in order to determine how to deal with the trustbase message 190. The data part may be read and changed by the services.

As the message is unwrapped by the protocol analyser, protocol handler and message reader, each piece of information which is known about the message is written into an attribute section. Common attributes written into the attribute section include transport protocol type, username, password, message source (hostname), message source (ipaddress), http headers, message MIME type and application specific message typing information.

Possible attributes include a role, a message type and the state of the message. The roles are defined by the services. The state may be one of authenticated or authorised. Authenticated means that the identity of the user has been verified by a verification service. Authorised means that a check that the user is authorised to access a particular service has been made.

The router 130 may route the trustbase message to one or more services 134, which perform some action using the data part 200 of the trustbase message. The router comprises a routing engine 144, an entitlements database 146 and a rules database 148.

The router 130 has two main functions, that is, primarily, routing messages according to its rules, and secondarily, modifying the attributes of a message.

The router routes a trustbase message by looking at its attributes. The routing engine 144 looks in its rules database 148 and applies the rules contained in the database to the attributes 202 of the message 190, to decide to which, if any, service 134 the message 190 should be sent. For example, if the message attributes 202 indicate the message 190 to be a request for an IDENTRUS status check, the rules database decides that the message should be addressed and sent to the IDENTRUS status checking service. The rules comprise Preconditions which if met indicate that certain Actions should be carried out. Each set of Preconditions leads to one Action only. The preconditions typically act on the attributes of a trustbase message only.

Before sending a message to a service, the router checks with its entitlements database 146 that the user is entitled to access that service, using the data held in the attributes section 202.

An example of rule-based routing is as follows:

RuleSet “configureX”
Rule “Configure”

| | |
|---|---|
| IF | state is “null” |
| AND | messageType is “A” |
| THEN | call service “configureX” |

Rule “Authenticate Administrator”

| | |
|---|---|
| IF | state is “postX” AND messageType is “A” |
| THEN | perform “authenticate administrator” |
| USING | this message |

Etc.

Each rule, for example Rule “Configure” and Rule “Authenticate Administrator”, belongs to a set of rules, for example the set “configureX”, where X is the name of a particular service on the system. The router deals with a message in accordance with its rules, and checks through these starting at the top of the list and working down. For example if the message is a new message and has the preconditions that its state attribute is “null” and that its messageType attribute is “A” then the service “X” will be called by virtue of the Action contained in rule “Configure”. Service X will carry out its function on the message and then change the “state” attribute of the message to indicate that the message has been through the function of that service, that is that it is “post-X”. The returning message would next be sent, in accordance with Rule “Authenticate Administrator” to perform the service “authenticate administrator”. If the messageType had not been “A” or if the state of the message had been different then the router would have moved on to check the attributes of the message against the next rule in the list.

There are two forms of Actions which may be specified in the rules. An “Execute Service” Action where an authorisation check must first be carried out by the Entitlements engine before sending on the message to the service; and an “Unauthorised Execute Service” Action where the service may be accessed without the authorisation check being carried out.

To improve the ease of routing and so that the system is flexible, services apply roles into which messages are sorted in dependence on their attributes. Once a role has been assigned the entitlements engine can easily check authorisation to a service by checking that there is a mapping between that role and the service to which the message is heading.

Roles are assigned to a message by a role mapping service which examines attributes of a message for username, password and certificate attributes. Matching attributes are looked up in an authentication database where they are matched to roles. Roles themselves and the items required to authenticate a message to a role are determined by the system administrator.

The services 134, which are provided in the message manager, are typically provided in the form of plug-ins. There may be any number of them in the message manager, and a message can be sent to any number of services in turn, in dependence on the rules.

The router decides on where a message should be sent using the attribute data 202 and context 204 only, that is without looking at the content of the data pay load itself. (Although this is not essential and the router may also check the contents of the data part 200). Therefore, the services have to change the attributes of a message to indicate to the router what that service has done to the data contained in the message, or to which service the message should next be sent. The services read and, if necessary, modify the data 200 contained in the trustbase message.

In addition to the internal services 134 of the message manager, the message manager is able to route an incoming message to an external service (not shown in FIG. 6), for example to the bank's certificate database or to a message manager of another certification authority. This message is sent through the connector 132 which does the inverse of the parser. It comprises its own protocol analyser and message analyser (not shown), and uses the message writers 142 and protocol handlers to write a message to be sent to an external service, and to wrap the message up, by adding the required message level and transport level protocols.

Referring again to FIG. 6, message RC 1 is received through the front end of the MM 100 of the RP that is through its parser, and message RP 1 is sent from the connector of RP's MM and received at the front end of IP's MM 101. Message IP 1 is sent from the connector of IP's MM 101 and received by the MM 102 of Identrus root through its parser. IR1 is sent back to the IP through the IP MM's 101 parser, that is out of the front end. IP2 is sent from the connector of the IP's MM 101 and received at the front end of RPs MM 100. RP2 is sent through the back end of MM 100, that is the connector of RP's MM 100, and received at the IR through the parser of its Message Manager. IR2 is sent through the front end of IR's MM 102 and received through RP's MM 100 front end. Finally, RP3 is sent through the front end of RP's MM 100.

One function of the protocol analyser (PA), namely establishing a context, will now be described in more detail. A context gives an indication of the state of an operation and this feature is particularly useful in respect of a transaction including a sequence of client/server messages. When a message is received by the message manager, the protocol analyser checks whether the message relates to a one or more messages which it has already processed, or whether this is the first message of a new message. For example a message may have been sent to the message manager in response to a request. The service will need to be able to tell whether a message received is the requested response, or something else. So a ‘context’ is needed.

The selected protocol handler determines a transaction ID (TXID). If an external TXID, that is one generated by some other non-MM apparatus is present in the message, that can be used. If a MM TXID is present that can also be used. Failing either of these the message is assumed to belong to a new message and the PA generates a new internal TXID.

The PA uses the TXID to look up a context from a database. If no context is found, a new one is created. The context is used where a series of messages will be involved in carrying out a single operation. Whilst the message may be sent out from the MM, the MM must be able to retain information about the state of the operation or transaction being carried out. So a “context” is set up. Whilst the message is in the MM the status of the message can be deduced from the context associated with the message and from the attributes of the message. When the message is sent out of the Message Manager the context will be stored and then later be reattached to the next incoming message having the same transaction ID.

An example will now be given referring to FIG. 10. A first message initiating a transaction may be sent from a client to the message manager including a message identifier “555”. This message could, for example, comprise a simple logon request. The selected protocol handler will detect the presence of the TXID 555 and the PA will then check to see whether there is a context stored in its database in respect of this ID. If not, then a new context, represented by a single frame, will be set up. In FIG. 10, a new context A, represented by two frames is recovered from the database. The first frame includes a user name or user ID and authorisation status of the user. A second frame includes an order status for a first operation. At any one time the context may be represented by one or more frames, which are updated as each step of a message takes place. When the first operation is complete (B) the second frame is deleted. The context then contains (C) just the first frame identifying the user details. Then, when the next operation is started one or more sub frames (frame 2D) will be created to include details about the status of that operation. Typically, the second frame will, in addition to including a status order, include an item list, listing the different items or tasks which must be completed in that operation.

The context is associated by the PA with the trustbase message before it is passed on to the router. Later, when the message leaves the system, for example when the message manager sends data to the client, the context of the message is stored in the context database.

Sometimes a service cannot deal with a request without first obtaining further information. For example a bank account number service may only be allowed to be accessed, according to the rules in the rules database, once the client's identity has been verified. Thus before a request “give me my account details, please”, can be answered, a subsidiary round of correspondence between the client and the MM is required, for example where the rules lay down that the account number service may not be accessed until the user has answered a security question. This subsidiary correspondence will include the same transaction identifier as it is part of the same transaction, but it will need to be identified as relating to a different context being a message belonging to the subsidiary round of correspondence only. Thus “sub-contexts” are used, identified by sub-frames in the context engine, and the router will replace the context attributes of the trustbase message with a sub-context, and invoke an authentication service. So in our example the Authentication Service may send a message, “Answer security question Z”, to the client under the TX ID 555, and the PA will create a sub-frame and store therein an indication of the status of the operation, referenced to that TX ID, in the context database. Then when the next message having the message identifier 555 is received, the PA, by searching through the context database, will find the appropriate context to be associated with the trustbase message. The trustbase message as well as the associated context will be passed to the Authentication checking service, which checks the answer provided by the user, and which will then modify the attributes of the message packet to indicate that the security question has been successfully answered. The service then passes the message back to the router and modifies the context of the message to reflect that the user has answered the security question correctly.

Preferably, the Authentication engine automatically checks the digital signature of every message which the Message Manager receives from outside, before conducting any further checks. The authentication engine will then modify the attributes of the message to indicate that the authentication has been carried out.

The router may also modifies the context of a message by changing the attributes of the context and of the message itself. The router may, depending on the rules, pass the message to the account number service, now that the attributes indicate that a security and identity check has been made. The account number service will then look up the account details and modify the data part of the trustbase message to include the account details and the attribute part to indicate that the data part includes the account details. The modified message is then passed back to the router which will then delete the sub-context for the operation of obtaining the account details and pass the message on to the protocol analyser. The message manager will maintain a context for the transaction so that it knows that it has already verified the identify of the client. Before sending the account details, the message manager will update the context for that message identifier to indicate the new status of the transaction so that it is ready to deal with the next request from that user. The parser will package the message by adding the appropriate message level and transport level protocols, before sending the account details to the client.

A trustbase message which has gone through both of the steps above will have attributes indicating that the identity has been checked and that the account details are included in the data part. Such a message may, according to the rules and because of these attributes, be able to access certain extra services, for example a service to withdraw money from that account.

Insofar as embodiments of the invention described above are implementable, at least in part, using a software-controlled programmable processing device such as a Digital Signal Processor, microprocessor, other processing devices, data processing apparatus or computer system, it will be appreciated that a computer program for configuring a programmable device, apparatus or system to implement the foregoing described methods is envisaged as an aspect of the present invention. The computer program may be embodied as source code and undergo compilation for implementation on a processing device, apparatus or system, or may be embodied as object code. The skilled person would readily understand that the term computer in its most general sense encompasses programmable devices such as referred to above, and apparatus and systems incorporating such programmable devices.

Suitably, the computer program is stored on a carrier medium in machine or device readable form, for example in solid-state memory or magnetic memory such as disc or tape and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A method for routing messages comprising: converting a message received from a sender into an internal format comprising at least an attribute part and a data part, writing into said attribute part data extracted from said received message; and routing said converted message in dependence on the data in said attribute part.

2. The method of claim 1, comprising identifying the format in which the message was received, and writing data identifying that format into said attribute part.

3. The method of claim 1, comprising determining where to send the message in dependence on the attributes.

4. The method of claim 1, comprising authenticating the identity of the sender of the message.

5. The method of claim 1, comprising identifying a set of services to which the message is addressed.

6. The method of claim 4, comprising determining whether the sender is authorised to access at least one service; and,
in dependence on the result of said authorisation determination, sending the converted message to the identified service.

7. The method of claim 6, in which said identified service updates the data held in the attribute part of the message.

8. The method of claim 6, comprising storing a plurality of routing rules and in which determining whether the sender is authorised to access at least one service comprises comparing said plurality of routing rules with the attributes of a converted message.

9. The method of claim 1, wherein said received message comprises a digital signature, the method comprising verifying the signature.

10. The method of claim 9, comprising writing into said attribute part data identifying the received digital signature.

11. The method of claim 1, comprising storing a plurality of routing rules; comparing the attributes of a converted message with the routing rules; and routing said converted message in dependence on said comparison.

12. The method of claim 1 comprising searching for a transaction identifier in the received message.

13. The method of claim 12, comprising allocating a new transaction identifier if no transaction identifier is detected in the received message.

14. The method of claim 12, comprising, if a transaction identifier is detected, searching for data identifying the status of a transaction by reference to the detected transaction identifier.

15. A program element comprising program code for configuring a computer system to route a message, the program code operable to:
convert a message received from a sender into an internal format comprising at least an attribute part and a data part;
write into said attribute part data extracted from said received message; and
route said converted message in dependence on the data in said attribute part.

16. A program element comprising program code translatable to configure a computer system to route a message, the program code operable to:
convert a message received from a sender into an internal format comprising at least an attribute part and a data part;
write into said attribute part data extracted from said received message; and route said converted message in dependence on the data in said attribute part.

17. A computer-readable medium encoded with computer-readable program code for configuring a computer system to route a message, the program code operable to:
convert a message received from a sender into an internal format comprising at least an attribute part and a data part;
write into said attribute part data extracted from said received message; and
route said converted message in dependence on the data in said attribute part.

18. A computer-readable medium encoded with computer-readable program code translatable to configure a computer system to route a message, the program code operable to:
convert a message received from a sender into an internal format comprising at least an attribute part and a data part;
write into said attribute part data extracted from said received message; and
route said converted message in dependence on the data in said attribute part.

19. A computer system for routing messages to one or more services comprising:
a parser for converting a message received from a sender into an internal format comprising an attribute part and a data part, said attribute part containing data extracted from the received message; and
a router for routing the converted message in dependence on the data in said attribute part.

20. The computer system of claim 19, in which said parser is configured to identify the format in which the message was received, and to write data identifying that format into said attribute part.

21. The computer system of claim 19, in which said router is configured to determine where to send the message in dependence on the attributes.

22. The computer system of claim 19, in which said the router is configured to authenticate the identity of the sender of the message.

23. The computer system of claim 19, in which said router is configured to identify a set of services to which the message is addressed.

24. The computer system of claim 19, in which said router is configured to: identify at least one service to which the message should be sent;
determine whether the sender is authorised to access said identified service; and,
in dependence on the result of said authorisation determination, selectively send the converted message to the identified service.

25. The computer system of claim 19, said router being configured to store a plurality of routing rules and to determine whether the sender is authorised to access a service by applying said rules to the attributes of a converted message.

26. The computer system of claim 19, wherein said parser is configured to verify signatures included in said received messages.

27. The computer system of claim 19, said parser comprising a plurality of applications for converting said received message, said parser selecting at least one of said applications in dependence on the data extracted from said received message.

28. The computer system of claim 27, wherein said data extracted from said received message includes a message type, said parser selecting at least one of said applications in dependence on the type of a message.

29. The computer system of claim 27, wherein said data extracted from said received message includes protocol data, and said parser selects at least one of said applications in dependence or the protocol(s) under which the message was received.

30. The computer system of claim 19, configured to search for a transaction identifier in the received message.

31. The computer system of claim 30, configured to allocate a new transaction identifier if no transaction identifier is detected in the received message.

32. The computer system of claim 30, configured to search for data identifying the status of a transaction by reference to the detected transaction identifier.

33. A computer system configured to provide a plurality of protocol handlers each configured to extract protocol data from a message received in a particular format.

34. A computer system according to claim 33, configured to select a protocol handler for extracting data from a received message, in dependence on the format in which the message is received.

35. A computer system according to claim 33 configured to select a protocol handler in dependence on the type of data in the received message.

36. A computer system according to claim 35, in which said protocol handler extracts message level protocol data and writes this into the attribute part of the converted message.

37. A computer program for routing messages, said program comprising computer executable instructions for converting a message received from a sender into an internal format comprising at least an attribute part and a data part, writing into said attribute part data extracted from said received message; and routing said converted message in dependence on the data in said attribute part.

38. The computer program of claim 37, comprising computer executable instructions for identifying the format in which the message was received, and writing data identifying that format into said attribute part.

39. The computer program of claim 37, comprising computer executable instructions for determining where to send the message in dependence on the attributes.

40. The computer program of claim 37, comprising computer executable instructions for authenticating the identity of the sender of the message.

41. The computer program of claim 37, comprising computer executable instructions for identifying a set of services to which the message is addressed.

42. The computer program of claim 37, comprising computer executable instructions for determining whether the sender is authorised to access at least one service; and,
in dependence on the result of said authorisation determination, sending the converted message to the identified service.

43. The computer program of claim 37, comprising computer executable instructions for searching for data identifying the status of a transaction by reference to a detected transaction identifier.

44. A computer system for routing messages to one or more services, comprising:
means for parsing a message received from a sender;
means for parsing including means for converting the message into an internal format comprising an attribute part and a data part, said attribute part containing data extracted from received message; and
means for routing the converted message in dependence on the data in the attribute part.

45. A computer network comprising at least one computer system connectable to at least one further computer system via a network, the at least one computer system comprising:
a parser for converting a message received from a sender into an internal format comprising an attribute part and a data part, said attribute part containing data extracted from the received message; and
a router for routing the converted message in dependence on the data in said attribute part.
